(19) United States
(12) Patent Application Publication
(10) Pub. No.: US 2014/0297271 A1
(43) Pub. Date: Oct. 2, 2014

(54) SPEECH SIGNAL ENCODING/DECODING METHOD AND APPARATUS

(71) Applicant: Binauric SE, Hallbergmoos (DE)

(72) Inventor: Bernd Geiser, Aachen (DE)

(73) Assignee: Binauric SE, Hallbergmoos (DE)

(21) Appl. No.: 14/228,035

(22) Filed: Mar. 27, 2014

(30) Foreign Application Priority Data
Mar. 27, 2013 (EP) 13001602.5

(51) Int. Cl. G10L 19/26

(52) U.S. Cl. CPC G10L 19/265
USPC 704/207

(57) ABSTRACT

The present invention relates to a speech signal encoding method for encoding an inputted first speech signal into a second speech signal having a narrower available bandwidth than the first speech signal. The method comprises generating a pitch-scaled version of higher frequencies of the first speech signal and including in the second speech signal lower frequencies of the first speech signal and the pitch-scaled version of the higher frequencies. At least a part of the higher frequencies are frequencies that are outside the available bandwidth of the second speech signal. The pitch-scaled version of the higher frequencies is preferably included in the second speech signal with a gain factor having a value of 1 or a value higher than 1. The present invention further relates to a corresponding speech signal decoding method for decoding an inputted first speech signal into a second speech signal having a wider available bandwidth than the first speech signal.

### BACKGROUND

1. Technical Field

The present invention generally relates to the encoding/decoding of speech signals. More particularly, the present invention relates to a speech signal encoding method and apparatus as well as to a corresponding speech signal decoding method and apparatus.

2. Description of the Related Art

### 1. Introduction

The human voice can produce frequencies ranging from approximately 30 Hz up to 18 kHz. However, when telephone communication started, bandwidth was a precious resource; the speech signal was therefore traditionally passed through a band-pass filter to remove frequencies below 0.3 kHz and above 3.4 kHz and was sampled at a sampling rate of 8 kHz. Although these lower frequencies are where most of the speech energy and voice richness is concentrated—and therefore certain consonants sound nearly identical when the higher frequencies are removed—, much of the intelligibility of human speech depends on the higher frequencies. As a result, telephone users often have difficulties discriminating the sound of letters such as “S and F” or “P and T” or “M and N”, making words such as “sailing and failing” or “patter and tatter” or “Manny and Nanny” more prone to misinterpretation over a traditional narrowband telephone connection.

For this reason, wideband speech transmission with a higher audio bandwidth than the traditional 0.3 kHz to 3.4 kHz frequency band is an essential feature for contemporary high-quality speech communication systems. Suitable codecs, such as the AMR-WB (see, e.g., ETSI, “ETSI TS 126 190: Adaptive Multi-Rate-Wideband (AMR-WB) speech codec; Transcoding functions,” 2001; B. Bessette et al., “The adaptive multirate wideband speech codec (AMR-WB),” IEEE Transactions on Speech and Audio Processing, Vol. 10, No. 8, November 2002, pp. 620-636), are available and offer a significantly increased speech quality and intelligibility compared to narrowband telephony. However, the requirement of backwards compatibility with existing equipment effectively precluded a timely deployment of the new technology. For example, “HD-Voice” transmission in cellular networks is only slowly being introduced.

Moreover, even if wideband transmission is supported by the receiving terminal and by the corresponding network operator, still the calling terminal or parts of the involved transmission chain may employ only narrowband codecs. Therefore, subscribers of HD-voice services will still experience inferior speech quality in many cases.

1.1. Relation to Prior Work

This specification presents a new solution for a backwards compatible transmission of wideband speech signals. In the literature, several attempts to maintain such compatibility have appeared, first to name techniques for “artificial bandwidth extension” (ABWE) of speech, i.e., (statistical) estimation of missing frequency components from the narrowband signal alone (see, e.g., H. Carl and U. Heute, “Bandwidth enhancement of narrow-band speech signals,” in Proceedings of European Signal Processing Conference (EUSIPCO), Edinburgh, Scotland, September 1994, pp. 1178-1181; P. Jax and P. Vary, “On artificial bandwidth extension of telephone speech,” Signal Processing, Vol. 83, No. 8, August 2003, pp. 1707-1719; H. Pulakka et al., “Speech bandwidth extension using Gaussian mixture model-based estimation of the highband mel spectrum,” in Proceedings of IEEE International Conference on Acoustics, Speech, and Signal Processing (ICASSP), Prague, Czech Republic, May 2011, pp. 5100-5103). For ABWE, there are in fact no further prerequisites apart from the mere availability of narrowband speech. Although this “receiver-only” approach constitutes the most generic solution, it suffers from an inherently limited performance which is not sufficient for the regeneration of high quality wideband speech signals. In particular, the regenerated wideband speech signals frequently contain artificial artifacts and short-term fluctuations or clicks that limit the achievable speech quality.

A much better wideband speech quality is obtained when some compact side information about the upper frequency band is explicitly transmitted. In case of a hierarchical coding, the bitstream of the codec used in the transmission system is enhanced by an additional layer (see, e.g., R. Taori et al., “Hi-BIN: An alternative approach to wideband speech coding,” in Proceedings of IEEE International Conference on Acoustics, Speech, and Signal Processing (ICASSP), Istanbul, Turkey, June 2000, pp. 1157-1160; B. Geiser et al., “Bandwidth extension for hierarchical speech and audio coding in ITU-T Rec. G.729.1,” IEEE Transactions on Audio, Speech, and Language Processing, Vol. 15, No. 8, November 2007, pp. 2496-2509). This additional bitstream layer comprises compact information—typically encoded with less than 2 kbit/s—for synthesizing the missing audio frequencies. The speech quality that can be achieved with this approach is comparable with dedicated wideband speech codecs such as AMR-WB.

On the other hand, hierarchical coding has a number of disadvantages. First of all, not only the terminal devices but effectively also the transmission format has to be modified. This means that existing network components which are not able to handle the enhanced bitstream format (and/or the higher total transmission rate) may need to discard the enhancement layer, whereby the possibility for increasing the bandwidth is effectively lost. Moreover, the enhancement layer is in most cases closely integrated with the utilized narrowband speech codec, so that the method is only applicable for this specific codec.

In order to ensure the desired backwards compatibility with respect to the transmission network, steganographic methods can be used that hide the side information bits in the narrowband signal or in the respective bitstream by using signal-domain watermarking techniques (see, e.g., B. Geiser et al., “Artificial bandwidth extension of speech supported by watermark-transmitted side information,” in Proceedings of INTERSPEECH, Lisbon, Portugal, September 2005, pp. 1497-1500; A. Sagi and D. Malah, “Bandwidth extension of telephone speech aided by data embedding,” EURASIP Journal on Applied Signal Processing, Vol. 2007, No. 1, January 2007, Article 64921) or “in-codec” steganography (see, e.g., N. Chétry and M. Davies, “Embedding side information into a speech codec residual,” in Proceedings of European Signal Processing Conference (EUSIPCO), Florence, Italy, September 2006; B. Geiser and P. Vary, “Backwards compatible wideband telephony in mobile networks: CELP watermarking and bandwidth extension,” in Proceedings of IEEE International Conference on Acoustics, Speech, and Signal Processing (ICASSP), Honolulu, Hi., USA, April 2007, pp. 533-536; B. Geiser and P. Vary, “High rate data hiding in ACELP speech codecs,” in Proceedings of IEEE International Conference on Acoustics, Speech, and Signal Processing (ICASSP), Las Vegas, Nev., USA, March 2008, pp. 4005-4008). The signal domain watermarking approach is, however, not robust against low-rate narrowband speech coding and, in practice, requires tedious synchronization and equalization procedures. In particular, it is not suited for use with the CELP codecs (Code-Excited Linear Prediction) used in today's mobile telephony systems. The “in-codec” techniques, in contrast, facilitate relatively high hidden bit rates, but, owing to the strong dependence on the specific speech codec, any hidden information will be lost in case of transcoding, i.e., the case where the encoded bitstream is first decoded and then again encoded with another codec.

### BRIEF SUMMARY

### 2. Objects and Solutions

It is an object of the present embodiments are to provide a speech signal encoding method and apparatus that allow inter alia for a wideband speech transmission which is backwards compatible with narrowband telephone systems.

It is a further object of the present embodiments to provide a corresponding speech signal decoding method and apparatus.

In a first aspect, a speech signal encoding method for encoding an inputted first speech signal into a second speech signal having a narrower available bandwidth than the first speech signal is presented, wherein the method comprises:

generating a pitch-scaled version of higher frequencies of the first speech signal, and

including in the second speech signal lower frequencies of the first speech signal and the pitch-scaled version of the higher frequencies of the first speech signal,

wherein at least a part of the higher frequencies of the first speech signal are frequencies that are outside the available bandwidth of the second speech signal, and

wherein the pitch-scaled version of the higher frequencies of the first speech signal is preferably included in the second speech signal with a gain factor having a value of 1 or a value higher than 1.

The present disclosure is based on the idea that when encoding a first speech signal (input) into a second speech signal (output) having a narrower available bandwidth than the first speech signal, it is possible by generating a pitch-scaled version of higher frequencies of the first speech signal, wherein at least a part of the higher frequencies of the first speech signal, the higher frequencies of the first speech signal being the frequencies of which a pitch-scaled version is generated, are frequencies that are outside the available bandwidth of the second speech signal, and by including in the second speech signal lower frequencies of the first speech signal and the pitch-scaled version of the higher frequencies of the first speech signal, to generate a second speech signal which includes information about higher frequencies of the first speech signal of which at least a part cannot normally be represented with the available bandwidth of the second speech signal. This approach can be used, e.g., to encode a wideband speech signal into a narrowband speech signal. Alternatively, it can also be used to encode a super-wideband speech signal into a wideband speech signal.

In the context of the present application, the term “narrowband speech signal” preferentially relates to a speech signal that is sampled at a sampling rate of 8 kHz, the term “wideband speech signal” preferentially relates to a speech signal that is sampled at a sampling rate of 16 kHz, and the term “super-wideband speech signal” preferentially relates to a speech signal that is sampled at a an even higher sampling rate, e.g., of 32 kHz. According to the well-known “Nyquist-Shannon sampling theorem” (also known as the “Nyquist sampling theorem” or simply the “sampling theorem”), a narrowband speech signal thus has an available bandwidth ranging from 0 Hz to 4 kHz, i.e., it can represent frequencies within this range, a wideband speech signal has an available bandwidth ranging from 0 Hz to 8 kHz, and a super-wideband speech signal has an available bandwidth ranging from 0 kHz to 16 kHz.

It is preferred that the frequency range of the higher frequencies of the first speech signal is outside the available bandwidth of the second speech signal.

It is further preferred that the frequency range of the higher frequencies of the first speech signal is larger than, in particular, four or five times as large as, the frequency range of the pitch-scaled version thereof, in particular, that the frequency range of the higher frequencies of the first speech signal is 2.4 kHz or 3 kHz large and the frequency range of the pitch-scaled version thereof is 600 Hz large, or that the frequency range of the higher frequencies of the first speech signal is 4 kHz large and the frequency range of the pitch-scaled version thereof is 1 kHz large.

It is particularly preferred that the frequency range of the higher frequencies of the first speech signal ranges from 4 kHz to 6.4 kHz or from 4 kHz to 7 kHz and the frequency range of the pitch-scaled version thereof ranges from 3.4 kHz to 4 kHz, or that the frequency range of the higher frequencies of the first speech signal ranges from 8 kHz to 12 kHz and the frequency range of the pitch-scaled version thereof ranges from 7 kHz to 8 KHz.

It is preferred that the encoding comprises providing the second speech signal with signaling data for signaling that the second speech signal has been encoded using the method according to any of claims 1 to 4.

It is further preferred that the encoding comprises:

separating the first speech signal into a low band time domain signal and a high band time domain signal,

transforming the low band time domain signal into a first frequency domain signal using a windowed transform having a first window length and a window shift, and transforming the high band time domain signal into a second frequency domain signal using a windowed transform having a second window length and the window shift,

wherein the ratio of the second window length to the first window length is equal to the pitch-scaling factor, preferably, equal to ¼ or ⅕.

Employing these steps allows for an elegant way of realizing the generation of the pitch-scaled version of the higher frequencies of the first speech signal and its inclusion in the second speech signal. In particular, it makes it possible to perform the inclusion task by simply copying those frequency coefficients of the second frequency domain signal that correspond to the transform of the higher frequencies of the first speech signal to an appropriate position within the first frequency domain signal. The second speech signal can then be generated by inverse transforming the (modified) first frequency domain signal using an inverse transform having the first window length and the window shift.

In a second aspect of the present disclosure, a speech signal decoding method for decoding an inputted first speech signal into a second speech signal having a wider available bandwidth than the first speech signal is presented, wherein the method comprises:

generating a pitch-scaled version of higher frequencies of the first speech signal, and

including in the second speech signal lower frequencies of the first speech signal and the pitch-scaled version of the higher frequencies of the first speech signal,

wherein at least a part of the pitch-scaled version of the higher frequencies of the first speech signal are frequencies that are outside the available bandwidth of the first speech signal, and

wherein the pitch-scaled version of the higher frequencies of the first speech signal is preferably included in the second speech signal with an attenuation factor having a value of 1 or a value lower than 1.

It is preferred that the frequency range of the pitch-scaled version of the higher frequencies of the first speech signal is outside the available bandwidth of the first speech signal.

It is further preferred that the frequency range of the higher frequencies of the first speech signal is smaller than, in particular, four or five times as small as, the frequency range of the pitch-scaled version thereof, in particular, that the frequency range of the higher frequencies of the first speech signal is 600 Hz large and the frequency range of the pitch-scaled version thereof is 2.4 kHz or 3 kHz large, or that the frequency range of the higher frequencies of the first speech signal is 1 kHz large and the frequency range of the pitch-scaled version thereof is 4 kHz large.

It is particularly preferred that the frequency range of the higher frequencies of the first speech signal ranges from 3.4 kHz to 4 kHz and the frequency range of the pitch-scaled version thereof ranges from 4 kHz to 6.4 kHz or from 4 kHz to 7 kHz, or that the frequency range of the higher frequencies of the first speech signal ranges from 7 kHz to 8 kHz and the frequency range of the pitch-scaled version thereof ranges from 8 kHz to 12 KHz.

It is preferred that the decoding comprises determining if the first speech signal is provided with signaling data for signaling that the first speech signal has been encoded using the method according to any of claims 1 to 6.

It is further preferred that the decoding comprises:

transforming the first speech signal into a first frequency domain signal using a windowed transform having a first window length and a window shift,

generating from transform coefficients of the first frequency domain signal, representing the higher frequencies of the first speech signal, a second frequency domain signal,

inverse transforming the second frequency domain signal into a high band time domain signal using an inverse transform having a second window length and an overlap-add procedure having the window shift, and

combining the first speech signal and the high band time domain signal, representing the pitch-scaled version of the higher frequencies of the first speech signal, to form the second speech signal,

wherein the ratio of the first window length to the second window length is equal to the pitch-scaling factor, preferably, equal to 4 or 5.

Employing these steps provides for an elegant way of realizing the generation of the pitch-scaled version of the higher frequencies of the first speech signal and its inclusion in the second speech signal. Preferably, the first and second window lengths used during decoding are equal to the first and second window lengths used during encoding (as described above) and the ratio of the window shift used during encoding to the window shift used during decoding is equal to the pitch-scaling factor used during decoding. The pitch-scaling factor used during encoding is preferably the reciprocal of the pitch-scaling factor used during decoding.

It is further preferred that generating the second speech signal comprises filtering out frequencies corresponding to the higher frequencies of the first speech signal.

In a third aspect of the present disclosure, a speech signal encoding apparatus for encoding an inputted first speech signal into a second speech signal having a narrower available bandwidth than the first speech signal is presented, wherein the apparatus comprises: generating means for generating a pitch-scaled version of higher frequencies of the first speech signal, including means for including in the second speech signal lower frequencies of the first speech signal and the pitch-scaled version of the higher frequencies of the first speech signal, wherein at least a part of the higher frequencies of the first speech signal are frequencies that are outside the available bandwidth of the second speech signal, and wherein the including means are preferably adapted to include the pitch-scaled version of the higher frequencies of the first speech signal in the second speech signal with a gain factor having a value of 1 or a value higher than 1.

In a fourth aspect of the present disclosure, a speech signal decoding apparatus for decoding an inputted first speech signal into a second speech signal having a wider available bandwidth than the first speech signal is presented, wherein the apparatus comprises: generating means for generating a pitch-scaled version of higher frequencies of the first speech signal. In one embodiment, a circuit, which may be controlled in part by software, performs this generating task.

The apparatus includes means for including in the second speech signal lower frequencies of the first speech signal and the pitch-scaled version of the higher frequencies of the first speech signal. In one embodiment, this included means is carried out by a combining module that may have software to aid in combining the frequencies of the different signals.

At least a part of the pitch-scaled version of the higher frequencies of the first speech signal are frequencies that are outside the available bandwidth of the first speech signal.

The including means are preferably adapted to include the pitch-scaled version of the higher frequencies of the first speech signal in the second speech signal with an attenuation factor having a value of 1 or a value lower than 1. In one embodiment, the combining module carries out the combination with an attenuation of 1 or less.

In a fifth aspect of the present invention, a computer program comprising program code means, which, when run on a computer, perform the steps of the method according to any of claims 1 to 6 and/or the steps of the method according to any of claims 7 to 12 is presented.

It shall be understood that the speech signal encoding method of claim 1, the speech signal decoding method of claim 7, the speech signal encoding apparatus of claim 13, the speech signal decoding apparatus of claim 14, and the computer program of claim 15 have similar and/or identical preferred embodiments, in particular, as defined in the dependent claims.

It shall be understood that a preferred embodiment of the invention can also be any combination of the dependent claims with the respective independent claim.

### BRIEF DESCRIPTION OF THE SEVERAL VIEWS OF THE DRAWINGS

These and other aspects of the invention will be apparent from and elucidated with reference to the embodiments described hereinafter. In the following drawings:

FIG. 1 shows a system overview. (The bracketed numbers reference the respective equations in the description.)

FIG. 2 shows spectrograms for an exemplary input speech signal. (The stippled horizontal lines are placed at 3.4, 4, and 6.4 kHz, respectively.)

FIG. 3 shows wideband speech quality (evg. WB-PESQ scores±std. dev.) after transmission over various codecs and codec tandems.

### DETAILED DESCRIPTION

### 3. Proposed Transmission System

The proposed transmission system constitutes an alternative to previous, steganography-based methods for backwards compatible wideband communication. The basic idea is to insert a pitch-scaled version of the higher frequencies (e.g., 4 kHz to 6.4 kHz) into the previously “unused” 3.4 kHz to 4 kHz frequency range of standard telephone speech which corresponds to a down-scaling factor of ρ=(6.4−4)(4−3.4)=¼. This operation is reverted at the decoder side (up-scaling factor 1/ρ=4).

Of the numerous pitch-scaling methods which are available (see, e.g., U. Zölzer, Editor, DAFX: Digital Audio Effects, 2nd edition, John Wiley & Sons Ltd., Chichester, UK, 2011), a comparatively simple DFT-domain technique turned out to be well-suited to realize the proposed system, because, in this case, the pitch scaling and the required frequency domain insertion/extraction operations can be carried out within the same signal processing framework. Besides, the concerned higher speech frequencies do not contain any dominant tonal components that could be problematic for the pitch scaling algorithm.

### 4. Encoder

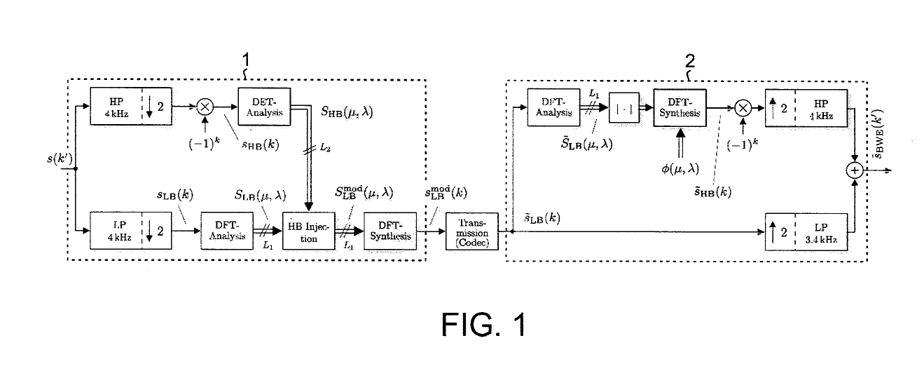

At the encoder side of the proposed system, shown with the reference numeral 1 in the left part of FIG. 1, the wideband speech signal s(k′) with its sampling rate of f′ₛ=16 kHz is first analyzed. Then the high frequency analysis result is inserted into the lower band. Finally, the modified narrowband speech s_{LB}^{mod}(k) is synthesized. The sampling rate of the subband signals is fₛ=8 kHz.

4.1. Analysis of Wideband Speech

The wideband signal s(k′) is first split into the two subband signals s_{LB}(k) and s_{HB}(k), e.g., with a half-band QMF filterbank. Then, for the lower frequency band in frame λ, a windowed DFT analysis is performed using a long window length L₁ and a large window shift S₁:

$${S}_{LB} ( μ , λ ) = {\sum }_{k = 0}^{{L}_{1} - 1} {s}_{LB} ( k + λ {S}_{1} ) {w}_{{L}_{1}} ( k ) \cdot {e}^{- 2 π j \frac{k μ}{{L}_{1}}} \qquad ( 1 )$$

for μ ∈{0, . . . , L₁−1}. The window function w_{L}_{₁}(k) is the square root of a Hann window of length L₁. Values of L₁=128 and S₁=32 have been chosen yielding a temporal resolution of S₁/fₛ=4 ms. The high band is analyzed with the same (large) window shift S₁, but with less spectral resolution, i.e., with a shorter window of length L₂=ρ·L₁=32:

$${S}_{HB} ( μ , λ ) = {\sum }_{k = 0}^{{L}_{2} - 1} {s}_{HB} ( k + κ ( λ ) + λ {S}_{1} ) {w}_{{L}_{2}} ( k ) \cdot {e}^{- 2 π j \frac{k μ }{{L}_{2}}} \qquad ( 2 )$$

for μ ∈{0, . . . , L₂−1}. Thereby, the actual window shift for frame λ is modified by the term κ(λ) which is given as:

$$κ ( λ ) = arg {min}_{κ ∈ \{ - {κ}_{0} , … , {κ}_{0} \}} {\sum }_{k = 0}^{{L}_{2} - 1} {s}_{HB}^{2} ( k + κ + λ {S}_{1} ) \qquad ( 3 )$$

with κ₀=8. This energy-minimizing choice of the window shift avoids audible fluctuations in the overall output signal \tilde{s}_{BSE}(k′). Note that the sequence of analysis windows in Eq. (2) does not necessarily overlap which, in effect, realizes the time-stretching by a factor of 1/ρ (or, respectively, the pitch-scaling by a factor of ρ).

4.2. High Frequency Injection

The analysis procedure, as described in detail above, has been designed such that (4 kHz−3.4 kHz)·L₁=2.4 kHz·L₂, i.e., the first 2.4 kHz of the analysis result of Eq. (2) fit in the upper 600 Hz of the analysis result of Eq. (1). Omitting the frame index λ as well as the (implicit) complex conjugate symmetric extension for μ>L₁/2, the high band injection procedure for the signal magnitude can be written as:

$$\vert {S}_{LB}^{mod} ( μ ) \vert = \{ \begin{matrix}\vert {S}_{LB} ( μ ) \vert & for μ < {μ}_{0} \\ {g}_{e} \frac{{L}_{1}}{{L}_{2}} \cdot \vert {S}_{HB} ( μ - {μ}_{0} ) \vert & for {μ}_{0} \leq μ \leq {μ}_{1}\end{matrix} \qquad ( 4 )$$

with μ₀=(L₁−└2.4/4·L₂┘)/2 and μ₁=L₁/2. With Eq. (4), the upper 600 Hz of |S_{LB}(μ)| are overwritten with the high band magnitude spectrum. The “injection gain” or “gain factor” gₑ can be set to 1 in most cases. However, higher values for gₑ can improve the robustness of the injected high band information against channel or coding noise, if desired. Note that the phase of S_{LB}(μ) is not modified here. Nevertheless, it can also be included in Eq. (4) to facilitate different high band reconstruction mechanisms, cf. Section 5.2.

4.3. Narrowband Re-Synthesis

The composite signal S_{LB}^{mod}(μ) is now transformed into the time domain by reverting the lower band analysis of Eq. (1), i.e., the IDFT uses the longer window length of L₁:

$${s}_{LB}^{mo d} ( k , λ ) = \frac{1}{{L}_{1}} {\sum }_{μ = 0}^{{L}_{1} - 1} {S}_{LB}^{mod } ( μ , λ ) \cdot {e}^{2 π j \frac{k μ}{{L}_{1}}} \qquad ( 5 )$$

for k ∈{0, . . . , L₁−1} and 0 outside the frame interval. The subsequent overlap-add procedure uses the larger window shift S₁, i.e.:

$${s}_{LB}^{mod} ( k ) = {\sum }_{λ} {S}_{LB}^{mod } ( k - λ {S}_{1} , λ ) {w}_{{L}_{1}} ( k - λ {S}_{1} ) \qquad ( 6 )$$

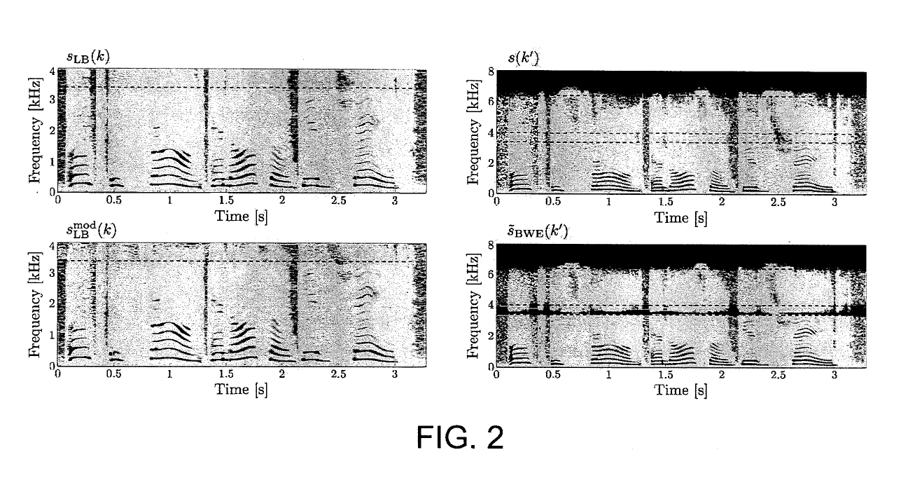

for all k. Note that, for compatibility reasons, the speech quality of s_{LB}^{mod}(k) must not be degraded compared to the original narrowband speech s_{LB}(k). This is examined in Section 6.1. Example spectrograms of s_{LB}^{mod}(k) and, for comparison, s_{LB}(k) are shown in left part of FIG. 2.

### 5. Decoder

At the decoder side, shown with the reference numeral 2 in the right part of FIG. 1, the received narrowband signal, denoted \tilde{s}_{LB}(k), is first analyzed, then the contained high band information is extracted and a high band signal \tilde{s}_{HB}(k) is synthesized which is finally combined with the narrowband signal to form the bandwidth extended output signal \tilde{s}_{BWE}(k′).

5.1. Analysis of the Received Narrowband Signal

The decoder side analysis of \tilde{s}_{LB}(k) uses the long window length L₁, but a small window shift S₂=ρ·S₁=8:

$${\tilde{S}}_{LB} ( μ , λ ) = {\sum }_{k = 0}^{{L}_{1} - 1} {\tilde{s}}_{LB} ( k + λ {S}_{2} ) {w}_{{L}_{1}} ( k ) \cdot {e}^{- 2 π j \frac{k μ}{{L}_{1}}} \qquad ( 7 )$$

for μ ∈{0, . . . , L₁−1}. This way, S₁/S₂=1/ρ times as many analysis results are available per time unit. These can be used to produce a pitch-scaled (factor 1/ρ) version of the contained high band signal.

5.2. Composition of the High Band Spectrum

The high band information (DFT magnitudes for 4-6.4 kHz) within the upper 600 Hz of \tilde{S}_{LB}(μ, λ) is now extracted and a (partly) synthetic DFT spectrum with L₂ bins is formed. Again, the frame index A and the (implicit) complex conjugate symmetric extension for μ>L₂/2 are disregarded. With g_{d}=1/gₑ and μ₀, μ₁ from Eq. (4), this gives:

$$\vert {\tilde{S}}_{HB} ( μ ) \vert = \{ \begin{matrix}{g}_{d} \cdot \vert {\tilde{S}}_{LB} ( μ + {μ}_{0} ) \vert & for 0 \leq μ \leq {μ}_{1} - {μ}_{0} \\ 0 & for {μ}_{1} - {μ}_{0} < μ \leq {L}_{2} / 2\end{matrix} \qquad ( 8 )$$

Compared to the DFT magnitudes, a correct representation of the phase is much less important for high-quality reproduction of higher speech frequencies (see, e.g., P. Jax and P. Vary, “On artificial bandwidth extension of telephone speech,” Signal Processing, Vol. 83, No. 8, August 2003, pp. 1707-1719). In fact, there are several alternatives to obtain a suitable phase ∠\tilde{S}_{HB}(μ). For example, an additional analysis of \tilde{s}_{LB}(k) with a window length of L₂ and a window shift of S₂ would facilitate the direct reuse of the narrowband phase, an approach which is often used in artificial bandwidth extension algorithms (see, e.g., P. Jax and P. Vary, “On artificial bandwidth extension of telephone speech,” Signal Processing, Vol. 83, No. 8, August 2003, pp. 1707-1719). Of course, also the original phase of the (pitch-scaled) high band signal could be used, if the insertion equation (4) was appropriately modified. However, the required phase post-processing (phase vocoder, see, e.g., U. Zölzer, Editor, DAFX: Digital Audio Effects, 2nd edition, John Wiley & Sons Ltd., Chichester, UK, 2011) turns out to be tedious for pitch scaling by a factor of ¼ followed by a factor of 4. In fact, for the present application, a simple random phase φ(μ)˜Unif(−π, π) already delivers a high speech quality, i.e.:

$$∠ {\tilde{S}}_{HB} ( μ ) = \{ \begin{matrix}∠Re \{ {\tilde{S}}_{HB} ( {μ}_{0} ) \} & for μ = 0 \\ 0 & for μ = {L}_{2} / 2 \\ ϕ ( μ ) & else\end{matrix} \qquad ( 9 )$$

5.3. Speech Synthesis

The (partly) synthetic DFT spectrum \tilde{S}_{HB}(μ, λ) is transformed into the time domain via an IDFT with the short window length L₂:

$${\tilde{s}}_{HB} ( k , λ ) = \frac{1}{{L}_{2}} {\sum }_{μ = 0}^{{L}_{2} - 1} {\tilde{S}}_{HB} ( μ , λ ) \cdot {e}^{2 π j \frac{k μ}{{L}_{2}}} \qquad ( 10 )$$

for k ∈{0, . . . , L₂−1} and 0 outside the frame interval. Now, for overlap-add, the small window shift S₂ is applied, i.e.:

$${\tilde{s}}_{HB} ( k ) = {\sum }_{λ} {\tilde{s}}_{HB} ( k - λ {S}_{2} , λ ) {w}_{{L}_{2}} ( k - λ {S}_{2} ) \qquad ( 11 )$$

for all k. With \tilde{s}_{HB}(k) and the corresponding low band signal \tilde{s}_{LB}(k), the final subband synthesis can be carried out, giving the bandwidth extended output signal \tilde{s}_{BWE}(k′). Note that the cutoff frequency of the lowpass filter is 3.4 kHz instead of 4 kHz so that the modified components within the narrowband signal are filtered out. Example spectrograms of \tilde{s}_{BWE}(k′) and, for comparison, s(k′) are shown in right part of FIG. 2. It shall be noted that the introduced spectral gap is known to be not harmful, as found out by different authors (see, e.g., P. Jax and P. Vary, “On artificial bandwidth extension of telephone speech,” Signal Processing, Vol. 83, No. 8, August 2003, pp. 1707-1719; H. Pulakka et al., “Evaluation of an Artificial Speech Bandwidth Extension Method in Three Languages,” IEEE Transactions on Audio, Speech, and Language Processing, Vol. 16, No. 6, August 2008, pp. 1124-1137).

### 6. Quality Evaluation

Two aspects need to be considered for the quality evaluation of the proposed system. First, the narrowband speech quality must not be degraded for “legacy” receiving terminals. Second, a good (and stable) wideband quality must be guaranteed by “new” terminals according to Section 5.

For the present evaluation, the narrow- and wideband versions of the ITU-T PESQ tool (see, e.g., ITU-T, “ITU-T Rec. P.862: Perceptual evaluation of speech quality (PESQ): An objective method for end-to-end speech quality assessment of narrow-band telephone networks and speech codecs,” 2001; A. W. Rix et al., “Perceptual evaluation of speech quality (PESQ)—A new method for speech quality assessment of telephone networks and codecs,” in Proceedings of IEEE International Conference on Acoustics, Speech, and Signal Processing (ICASSP), Salt Lake City, Utah, USA, May 2001, pp. 749-752) have been used. The test set comprised all American and British English speech samples of the NTT database (see, e.g., NTT, “NTT advanced technology corporation: Multilingual speech database for telephonometry,” online: http:www.ntt-at.com/products_e/speech/, 1994), i.e., ≈25 min of speech.

6.1. Narrowband Speech Quality

A “legacy” terminal simply plays out the (received) composite narrowband signal \tilde{s}_{LB}(k). The requirement here is that the quality must not be degraded compared to conventionally encoded narrowband speech. Here, no codec has been used, i.e., \tilde{s}_{LB}(k)=s_{LB}^{mod}(k). This signal scored an average PESQ value of 4.33 with a standard deviation of 0.07 compared to the narrowband reference signal s_{LB}(k) which is only marginally less than the maximum achievable narrowband PESQ score of 4.55.

Subjectively, it can be argued that the inserted (pitch-scaled) high frequency band induces a slightly brighter sound character that can even improve the perceived narrowband speech quality.

6.2. Wideband Speech Quality

A receiving terminal which is aware of the pitch-scaled high frequency content within the 3.4-4 kHz band can produce the output signal \tilde{s}_{BWE}(k′) with audio frequencies up to 6.4 kHz. For a fair comparison, the reference signal s(k′) is lowpass filtered with the same cut-off frequency.

The wideband PESQ evaluation shows that, if no codec is used (\tilde{s}_{LB}(k)=s_{LB}^{mod}(k)), an excellent score of 4.43 is obtained with a standard deviation of 0.07. Also the subjective listening impression confirms the high-quality wideband reproduction without any objectionable artifacts.

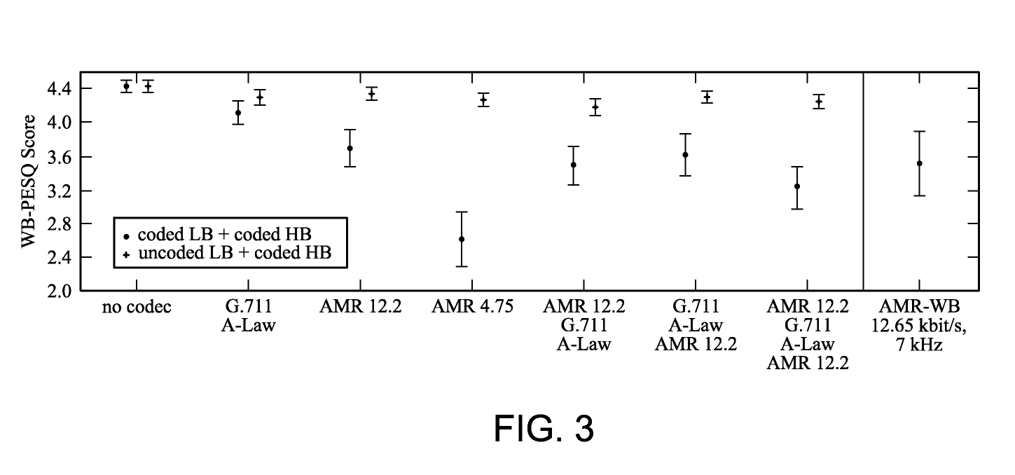

However, the question remains, in how far typical codecs impair the pitch-scaled 3.4-4 kHz band within s_{LB}^{mod}(k). Therefore, the ITU-T G.711 A-Law compander (see, e.g., ITU-T, “ITU-T Rec. G.711: Pulse code modulation (PCM) of voice frequencies,” 1972) and the 3GPP AMR codec (see, e.g., ETSI, “ETSI EN 301 704: Adaptive multi-rate (AMR) speech transcoding (GSM 06.90),” 2000; E. Ekudden et al., “The adaptive multi-rate speech coder,” in Proceedings of IEEE Workshop on Speech Coding (SCW), Porvoo, Finland, June 1999, pp. 117-119) at bit rates of 12.2 and 4.75 kbit/s have been chosen. Also, several codec tandems (multiple re-encoding) are investigated. The respective test results are shown in FIG. 3. The dot markers represent the quality of \tilde{s}_{BWE}(k′) which is often as good as (or even better than) that of AMR-WB (see, e.g., ETSI, “ETSI TS 126 190: Adaptive Multi-Rate-Wideband (AMR-WB) speech codec; Transcoding functions,” 2001; B. Bessette et al., “The adaptive multirate wideband speech codec (AMR-WB),” IEEE Transactions on Speech and Audio Processing, Vol. 10, No. 8, November 2002, pp. 620-636) at a bit rate of 12.65 kbit/s. In contrast, the plus markers represent the quality that is obtained when the original low band signal s_{LB}(k) is combined with the re-synthesized high band signal \tilde{s}_{HB}(k) after transmission over the codec or codec chain. This way, the quality impact on the high band signal can be assessed separately. The respective average wideband PESQ scores do not fall below 4.2 which still indicates a very high quality level.

Another short test revealed that the new system is also robust against sample delays between encoder and decoder. A transmission over analog lines has not yet been tested. However, if necessary, the “injection gain” or “gain factor” gₑ in Eq. (4) can still be increased without exceedingly compromising the narrowband quality.

### 7. Discussion

The proposed system facilitates fully backwards compatible transmission of higher speech frequencies over various speech codecs and codec tandems. As shown in FIG. 3, even after repeated new coding, the bandwidth extension is still of high quality. Here, in particular, the case AMR-to-G.711-to-AMR is of high relevance, because it covers a large part of today's mobile-to-mobile communications. Especially in communications that are not conducted exclusively within the network of a single network supplier, it is still often necessary in the core network to transcode to the G.711 codec. In addition, the computational complexity is expected to be very moderate. The only remaining prerequisite concerning the transmission chain is that no filtering such as IRS (see, e.g., ITU-T, “ITU-T Rec. P.48: Specification for an intermediate reference system,” 1976) must be applied. Also, an (in-band) signaling mechanism for wideband operation is required. The excellent speech quality is achieved despite the heavy pitch-scaling operations because there are no dominant tonal components in the considered frequency range. Hence, a simple “noise-only” model with sufficient temporal resolution (S₁/fₛ=4 ms) can be employed. Note that, if bandwidth extension towards the more common 7 kHz is desired, a pitch-scaling factor of 5 instead of 4 can be avoided if the 6.4 kHz to 7 kHz band is regenerated by fully receiver-based ABWE as, e.g., included in the AMR-WB codec (see, e.g., ETSI, “ETSI TS 126 190: Adaptive Multi-Rate-Wideband (AMR-WB) speech codec; Transcoding functions,” 2001; B. Bessette et al., “The adaptive multirate wideband speech codec (AMR-WB),” IEEE Transactions on Speech and Audio Processing, Vol. 10, No. 8, November 2002, pp. 620-636).

### Further Remarks

When the speech signal encoding method and apparatus of the present invention are used for encoding a wideband speech signal into a narrowband speech signal, i.e., the first speech signal is a wideband speech signal and the second speech signal is a narrowband speech signal, and the frequency range of the pitch-scaled version of the higher frequencies of the first speech signal ranges from 3.4 kHz to 4 kHz, the “extra” information in the narrowband speech signal may be audible, but the audible difference usually does not result in a reduction of speech quality. In contrast, it seems that the speech quality is even improved by the “extra” information. At least, the intelligibility seems to be improved, because the narrowband speech signal now comprises information about fricatives, e.g., /s/ or /f/, which cannot normally be represented in a conventional narrowband speech signal. Because the “extra” information does at least not have a negative impact of the speech quality when the narrowband speech signal comprising the “extra” information is reproduced, the proposed system is not only backwards compatible with the network components of existing telephone networks but also backwards compatible with conventional receivers for narrowband speech signals.

The speech signal decoding method and apparatus according to the present invention are preferably used for decoding a speech signal that has been encoded by the speech encoding method resp. apparatus according to the present invention. However, they can also be used to advantage for realizing an “artificial bandwidth extension”. For example, it is possible to pitch-scale “original” higher frequencies, e.g., within a frequency range ranging from 7 kHz to 8 kHz, of a conventional wideband speech signal to generate “artificial” frequencies within a frequency range ranging from 8 kHz to 12 kHz and to generate a super-wideband speech signal using the original frequencies of the wideband speech signal and the generated “artificial” frequencies. When used for such an “artificial bandwidth extension”, it may be particularly advantageous to include the pitch-scaled version of the higher frequencies of the first speech signal, in this example, the conventional wideband speech signal, in the second speech signal, in this example, the super-wideband speech signal, with an attenuation factor having a value lower than 1, so that the “artificial” frequencies are not perceived as strongly as the original frequencies.

Other variations to the disclosed embodiments can be understood and effected by those skilled in the art in practicing the claimed invention, from a study of the drawings, the disclosure, and the appended claims.

In the claims, the word “comprising” does not exclude other elements or steps, and the indefinite article “a” or “an” does not exclude a plurality.

A single unit or device may fulfill the functions of several items recited in the claims. The mere fact that certain measures are recited in mutually different dependent claims does not indicate that a combination of these measures cannot be used to advantage.

Any reference signs in the claims should not be construed as limiting the scope.

The various embodiments described above can be combined to provide further embodiments. All of the U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified, if necessary to employ concepts of the various patents, application and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A speech signal encoding method for encoding an inputted first speech signal into a second speech signal having a narrower available bandwidth than the first speech signal, wherein the method comprises:
generating a pitch-scaled version of higher frequencies of the first speech signal, and
including in the second speech signal lower frequencies of the first speech signal and the pitch-scaled version of the higher frequencies of the first speech signal,
wherein at least a part of the higher frequencies of the first speech signal are frequencies that are outside the available bandwidth of the second speech signal, and
wherein the pitch-scaled version of the higher frequencies of the first speech signal is preferably included in the second speech signal with a gain factor having a value of 1 or a value higher than 1.

2. The method according to claim 1, wherein the frequency range of the higher frequencies of the first speech signal is outside the available bandwidth of the second speech signal.

3. The method according to claim 1, wherein the frequency range of the higher frequencies of the first speech signal is larger than, in particular, four or five times as large as, the frequency range of the pitch-scaled version thereof, in particular, wherein the frequency range of the higher frequencies of the first speech signal is 2.4 kHz or 3 kHz large and the frequency range of the pitch-scaled version thereof is 600 Hz large, or wherein the frequency range of the higher frequencies of the first speech signal is 4 kHz large and the frequency range of the pitch-scaled version thereof is 1 kHz large.

4. The method according to claim 3, wherein the frequency range of the higher frequencies of the first speech signal ranges from 4 kHz to 6.4 kHz or from 4 to 7 kHz and the frequency range of the pitch-scaled version thereof ranges from 3.4 kHz to 4 kHz, or wherein the frequency range of the higher frequencies of the first speech signal ranges from 8 kHz to 12 kHz and the frequency range of the pitch-scaled version thereof ranges from 7 kHz to 8 KHz.

5. The method according to claim 1, wherein the encoding comprises providing the second speech signal with signaling data for signaling that the second speech signal has been encoded using the method according to claim 1.

6. The method according to claim 1, wherein the encoding comprises:
separating the first speech signal into a low band time domain signal and a high band time domain signal,
transforming the low band time domain signal into a first frequency domain signal using a windowed transform having a first window length and a window shift, and transforming the high band time domain signal into a second frequency domain signal using a windowed transform having a second window length and the window shift,
wherein the ratio of the second window length to the first window length is equal to the pitch-scaling factor, preferably, equal to ¼ or ⅕.

7. A speech signal decoding method for decoding an inputted first speech signal into a second speech signal having a wider available bandwidth than the first speech signal, wherein the method comprises:
generating a pitch-scaled version of higher frequencies of the first speech signal, and
including in the second speech signal lower frequencies of the first speech signal and the pitch-scaled version of the higher frequencies of the first speech signal,
wherein at least a part of the pitch-scaled version of the higher frequencies of the first speech signal are frequencies that are outside the available bandwidth of the first speech signal, and
wherein the pitch-scaled version of the higher frequencies of the first speech signal is preferably included in the second speech signal with an attenuation factor having a value of 1 or a value lower than 1.

8. The method according to claim 7, wherein the frequency range of the pitch-scaled version of the higher frequencies of the first speech signal outside the available bandwidth of the first speech signal.

9. The method according to claim 7, wherein the frequency range of the higher frequencies of the first speech signal is smaller than, in particular, four or five times as small as, the frequency range of the pitch-scaled version thereof, in particular, wherein the frequency range of the higher frequencies of the first speech signal is 600 Hz large and the frequency range of the pitch-scaled version thereof is 2.4 kHz or 3 kHz large, or wherein the frequency range of the higher frequencies of the first speech signal is 1 kHz large and the frequency range of the pitch-scaled version thereof is 4 kHz large.

10. The method according to claim 9, wherein the frequency range of the higher frequencies of the first speech signal ranges from 3.4 kHz to 4 kHz and the frequency range of the pitch-scaled version thereof ranges from 4 kHz to 6.4 kHz or from 4 kHz to 7 kHz, or wherein the frequency range of the higher frequencies of the first speech signal ranges from 7 kHz to 8 kHz and the frequency range of the pitch-scaled version thereof ranges from 8 kHz to 12 KHz.

11. The method according to claim 7, wherein the decoding comprises determining if the first speech signal is provided with signaling data for signaling that the first speech signal has been encoded using the method according to claim 1.

12. The method according to claim 7, wherein the decoding comprises:
transforming the first speech signal into a first frequency domain signal using a windowed transform having a first window length and a window shift,
generating from transform coefficients of the first frequency domain signal, representing the higher frequencies of the first speech signal, a second frequency domain signal,
inverse transforming the second frequency domain signal into a high band time domain signal using an inverse transform having a second window length and an overlap-add procedure having the window shift, and
combining the first speech signal and the high band time domain signal, representing the pitch-scaled version of the higher frequencies of the first speech signal, to form the second speech signal,
wherein the ratio of the first window length to the second window length is equal to the pitch-scaling factor, preferably, equal to 4 or 5.

13. A speech signal encoding apparatus for encoding an inputted first speech signal into a second speech signal having a narrower available bandwidth than the first speech signal, wherein the apparatus comprises:
generating means for generating a pitch-scaled version of higher frequencies of the first speech signal, and
including means for including in the second speech signal lower frequencies of the first speech signal and the pitch-scaled version of the higher frequencies of the first speech signal,
wherein at least a part of the higher frequencies of the first speech signal are frequencies that are outside the available bandwidth of the second speech signal, and
wherein the including means are preferably adapted to include the pitch-scaled version of the higher frequencies of the first speech signal in the second speech signal with a gain factor having a value of 1 or a value higher than 1.

14. A speech signal decoding apparatus for decoding an inputted first speech signal into a second speech signal having a wider available bandwidth than the first speech signal, wherein the apparatus comprises:
a generating circuit configured to generate a pitch-scaled version of higher frequencies of the first speech signal, and
a combining module for including in the second speech signal lower frequencies of the first speech signal and the pitch-scaled version of the higher frequencies of the first speech signal,
wherein at least a part of the pitch-scaled version of the higher frequencies of the first speech signal are frequencies that are outside the available bandwidth of the first speech signal, and
wherein the combining module is adapted to include the pitch-scaled version of the higher frequencies of the first speech signal in the second speech signal with an attenuation factor having a value of 1 or a value lower than 1.

15. A computer program comprising program code, which, when run on a computer, will cause the computer to perform the steps of the method according to claim 1.
